(19) United States
(12) Patent Application Publication
(10) Pub. No.: US 2010/0237654 A1
(43) Pub. Date: Sep. 23, 2010

(54) Folding and tilting truck mount carrier body

(76) Inventors: Brian Pannone, Alexis, NC (US); Michele Anne Pannone, Alexis, NC (US)

Correspondence Address: Brian Aaron Pannone, 2784 W White Pine Avenue, San Bernardino, CA, 92407, US

(21) Appl. No.: 12/322,059

(22) Filed: Mar. 20, 2009

(51) Int. Cl. B62D 33/02; B62D 25/20

(52) U.S. Cl. 296/184.1

(57) ABSTRACT

A truck mounted carrier body having a front and rear section connected with hinges is disclosed. The front body section comprises a front bed section mounted to a sub frame. This section maybe operated in the flat or tilted position. The rear section of the body when slid rearward to the load position allows ground loading capability. The forward and rear body sections are connected with a hinge. Sub frame connects to the rear truck frame with a hinge and front with hydraulic cylinders. A roller assembly mounted to the body glides the front sub frame and rear slope assembly. The rear slope assembly hinged at the rear will guide the rear body tail section to the ground, under the rear slope assembly stabilizer feet will push carrier bed to a dock height. A hydraulic cylinder mounted to the sub frame will allow forward and rearward slide operation of carrier.

### FIELD OF INVENTION

The present invention relates to a truck mounted industrial carrier body. More particularly, the invention is a truck mounted industrial carrier body which has front and rear sections hinged and connected together, whereby the truck body slides rearward allowing the rear truck body section or tail section to reach the ground. The front section can be operated in a flat level deck position or tilted to match the load angle of the rear or tail body section. This application is performed with the use of hydraulic and roller system.

### BACKGROUND OF INVENTION

Truck mounted industrial carrier bodies for the use and hauling items ranging from material handling, aerial lift devices, vehicles, construction rental equipment, palletized freight, and empty containers. All of these truck mounted industrial beds, however, generally have either one solid full tilt bed, or a forward stationary bed with a hinged hydraulic rear flip tail. All have the capability of ground load and off loading.

One common problem owners of full deck tilt truck mounted industrial carrier bodies have is that when loading equipment with no brakes safety becomes a factor. When loading equipment onto a truck body with a stationary deck and flip hydraulic tail, the load angle is slippery in wet conditions.

Another problem associated with truck mounted industrial carrier bodies with fixed decks and flipped tails, is the position of the trucks rear drive axle, the load is positioned directly over the axle or rearward of axle, causing excessive weight to drive axle and lightened weight to steer axle.

A truck mounted industrial carrier body that the axles set under the rear tail section bridge the weight better between the axles allowing the transportation of the equipment safer at both the steer and drive axles. A unit that has a single section tail assembly allows for safer operation by the operator rather than the use of a multi-fold tail or rear body section. With a body that has the versatility of loading onto a flat surface, with an option of also tilting to match the load angle of the tail. This allows the operator to safely load empty containers, low ground clearance equipment such as automobiles or aerial lift equipment that may not be able to clear the transition points between the rear tail section and flat forward body section.

Most commonly used with a flip hydraulic tail section are multiple hydraulic cylinders, hinges, and linkages which require several hydraulic control functions to unfold the tail to the ground. The flip tail's lift capacity is only the weight of the tail. With the unit described, only one control is needed to slide the tail section the ground position, with a lift and carrying capacity equal to the bed's capacity.

A truck mounted industrial carrier body with the versatility, safe operating, safe transportability, and lift capacity which is adaptable for easy loading and unloading as desired.

### SUMMARY OF THE INVENTION

The present invention is an improved truck mounted industrial truck body. With the bodies front and rear sections hinged connected to one another on opposite sides of a part line.

The hinged nature of the truck body allows a user to utilize the truck body in one of three main positions. First the user may tilt the rear tail section of the truck body downwardly by sliding the front body section rearward, the rear section forming a ramp between the ground and the front section, where by offering a flat surface to load on. Second, the user may tilt the front section matching the load angle of the rear section, where by the total length of the body will be in the tilted position allowing long or low ground clearance equipment to be loaded. Lastly, with the hydraulic tilt assembly, the rear tail section maybe raised to dock height or lowered to transport position

The front section of the truck body of the present invention comprises of a front bed section connected to a front sub frame section. The front sub frame section is mounted at the rear of the truck frame with a hinge and at the front with hydraulic cylinders. The rear sub frame slope assembly section is mounted rear of the truck frame with a hinge. The forward and rear main body sections that are connected with a hinge and a fabricated positive lock roller system that glides freely within the front sub frame and on top of the rear slope assembly. The hydraulic system operates the bed by sliding it rearward to the load position and forward to the transport position. The forward body section can be tilted hydraulically to match the rear tail sections load angle. Lastly, the rear slope assembly tilt system allows the rear tail section to raise to a dock height load position or lower to the level transport position.

The truck mounted industrial carrier body includes a four spool hydraulic valve body which operate the bed slide, bed tilt, stabilizer tilt for dock height, and hydraulic winch functions. The hydraulic winch mounted at the front of the forward mounted body section allows one to winch on any disabled equipment. A wireless remote control is also included in order to allow the safe operation of one operator. Cross members on 8 inch centers offers the strength and stability needed to safely load industrial equipment. Both driver side and passenger side of truck body will include several key hole slot tie downs and strap ratchet tie downs for the safe securement when loading equipment. Lastly, a trailer hitch will be fabricated to the rear slope assembly, offering versatile hook ups for the customer.

Further objects, features, and advantages of the present invention over the prior art will become apparent from the detailed description of the drawings, which follows, when considered with the following attached figures.

### DESCRIPTION OF THE DRAWINGS

FIG. 1 Sub Frame and rear roller slope assembly

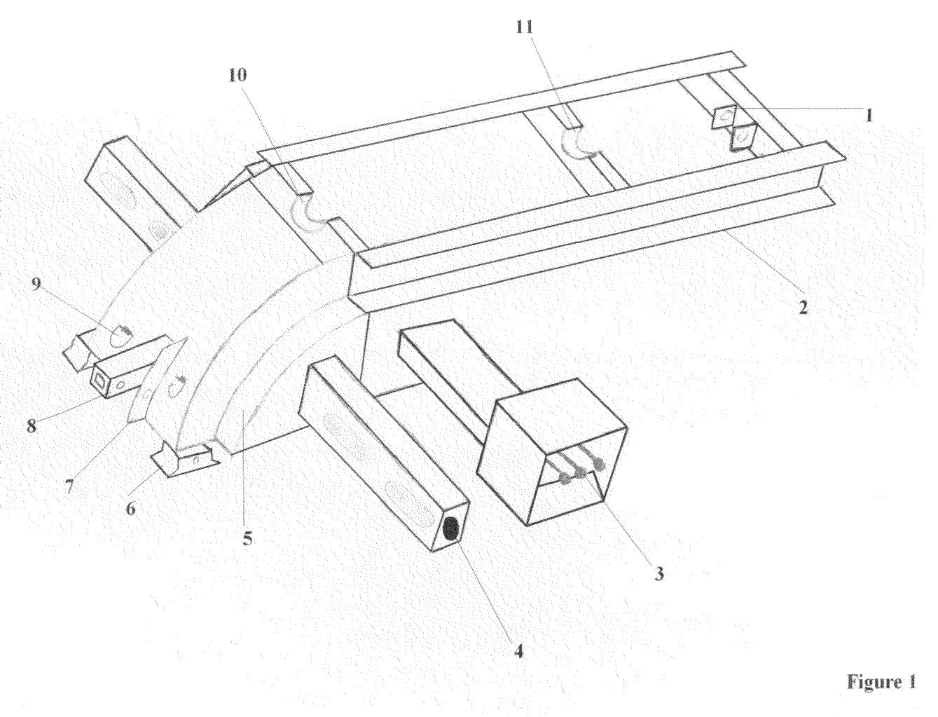

FIG. 2 Rear View of sub frame and carrier body rear roller slope assembly

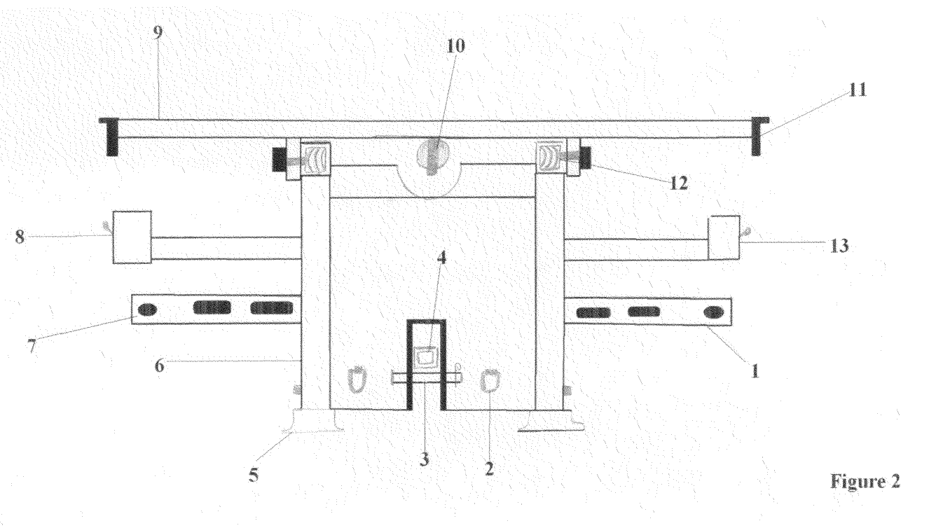

FIG. 3 Side View mechanical of carrier bed, roller sub frame slope assembly and hydraulic mechanisms

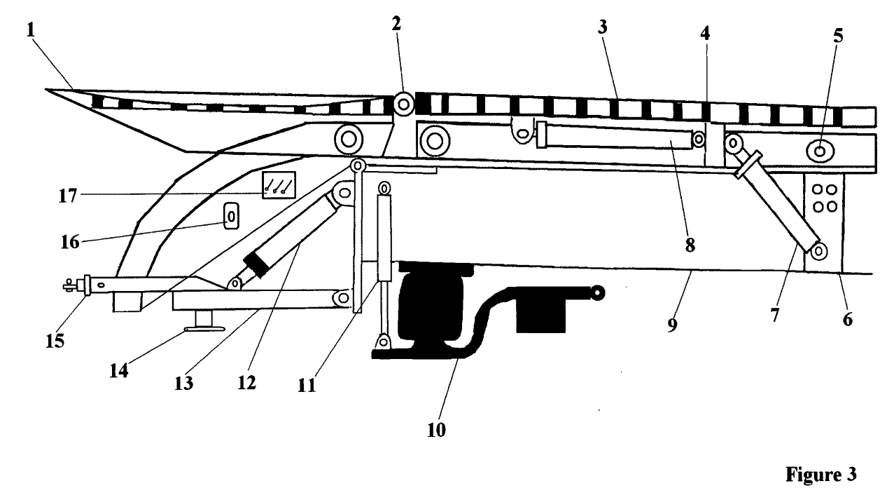

FIG. 4 Carrier body in transport position side view

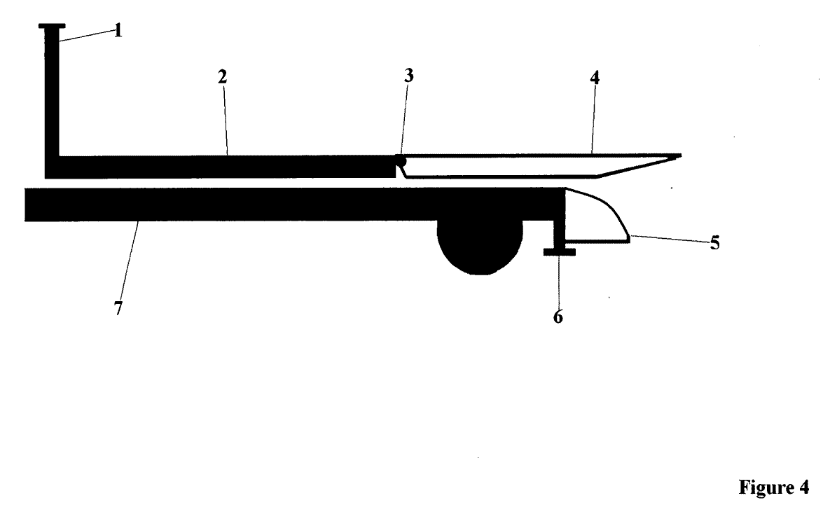

FIG. 5 Carrier body in 1^{st} rearward load position

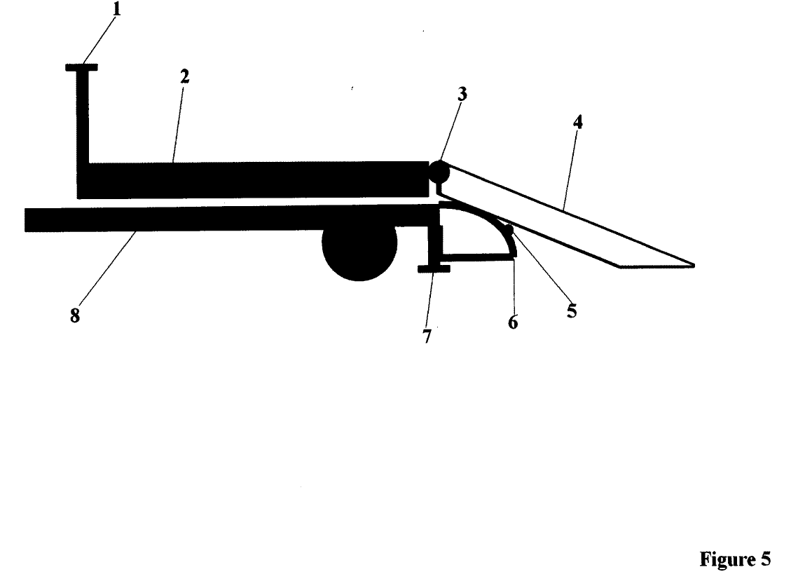

FIG. 6 Carrier body in rearward complete tilt loading position

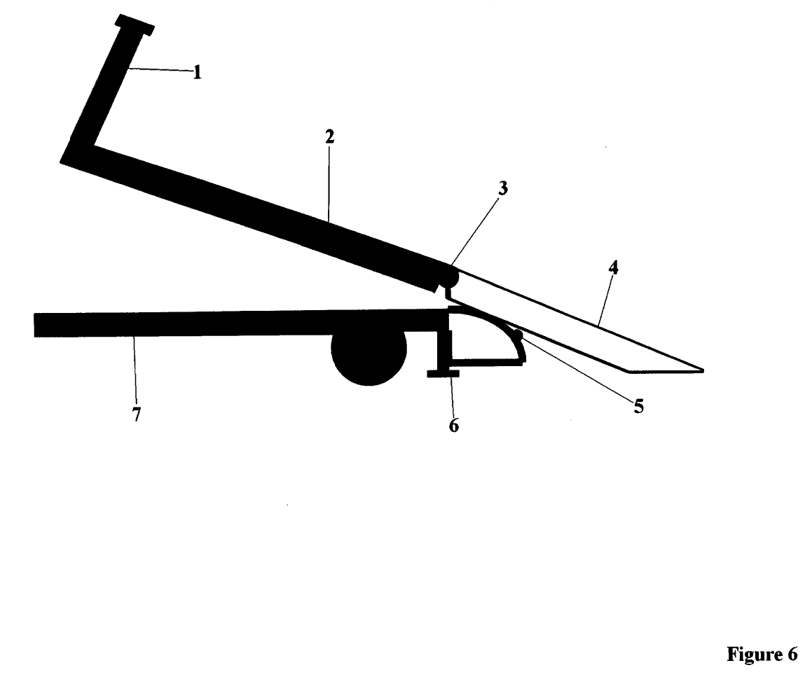

1. We Feel the Double Knuckle allows the operator the option of loading in a half tilted position with a flat deck section, or move into a full tilted position using the whole deck in a tilted position. In the current market buyers can only achieve one of two of these features from the current competition. As with our design we have taken both features and put them into one unique design.
